(19) United States
(12) Patent Application Publication
(10) Pub. No.: US 2009/0289905 A1
(43) Pub. Date: Nov. 26, 2009

(54) Touch input recognition methods and apparatuses

(75) Inventor: Se-Ho Ahn, Seongnam-city (KR)

Correspondence Address: HARNESS, DICKEY & PIERCE, P.L.C., P.O. BOX 8910, RESTON, VA, 20195, US

(73) Assignee: KTF TECHNOLOGIES, INC.

(21) Appl. No.: 12/216,480

(22) Filed: Jul. 7, 2008

(30) Foreign Application Priority Data
May 22, 2008 (KR) 2008-0047322
Jun. 30, 2008 (KR) 2008-0057670

(51) Int. Cl. G06F 3/041

(52) U.S. Cl. 345/173

(57) ABSTRACT

Touch input recognition methods and apparatuses can increase the accuracy of the recognition of touch input from user and reduce processing load in recognizing the touch input. When at least one coordinate value corresponding to a touch trace is received at a given time interval, an inflection point based on the received at least one coordinate value is determined. When a predetermined coordinate value of the at least one coordinate value is a coordinate value of the inflection point, a symbol value is set based on an increment/decrement feature of at least one coordinate value provided before the predetermined coordinate value. Finally, an event corresponding to the set symbol value is retrieved. Thus, the event corresponding to a touch input from a user is retrieved and executed based on an increment/decrement feature of a coordinate value, thereby reducing a processing load and a false recognition rate.

### CROSS-REFERENCE TO RELATED APPLICATION

This application claims priority to and the benefit of Korean Patent Applications No. 2008-47322, filed May 22, 2008, and No. 2008-57670, filed Jun. 19, 2008, the disclosure of which is incorporated herein by reference in its entirety.

### BACKGROUND

1. Field of the Invention

The present invention relates to touch input recognition methods and apparatuses and, more particularly, to touch input recognition methods and apparatuses applicable to devices having touch interface.

2. Discussion of Related Art

With the rapid development of processor technology, the increase in memory capacity, and the development of multimedia encoding technology, a variety of functions of portable devices such as handheld phones, personal digital assistants (PDAs), and the like have recently been provided.

As various portable device functions are provided, the number of menus using the portable device functions is increasing. Thus, a keypad having a fixed matrix arrangement is no longer suitable for using the various portable device functions.

As application programs provided in the portable devices develop from a numerical or text-based interface to a graphical interface, conventional alphanumeric and directional keys may become inefficient. Also, as many portable devices have an application program to reproduce multimedia and display images of the mobile Internet or the like, demand for wide-screen displays is increasing.

According to this trend, many portable devices are adopting a touch screen capable of simultaneously performing an input operation and a display operation in one device without a special keypad.

Since the portable device may be used interactively and intuitively by simply touching a button or graphic entity displayed on a display region of the touch screen with a finger or stylus, an input operation is simplified.

Since the portable device having the touch screen may perform the display operation in a state in which a displayed input interface entity is optimized for a corresponding application program, a user may more easily recognize an input interface to perform the input operation.

Since the touch screen integrates a display and a keypad, the conventional portable device's separate keypad installation space is not needed. Thus, the portable device may adopt a wider display.

Touch screens are classified according to operation method into a contact capacitive type, infrared sensing type, surface acoustic wave type, piezoelectric type, integral tension measurement type, and resistive type. Since the resistive touch screen has high transmittance, fast reaction speed, excellent tolerance, and is not largely affected by an operating environment, it is widely used.

However, since the portable device is manufactured with a small size for portability, the size of its touch screen and the number of menu items or buttons that it can display are limited.

In order to make up for the above-described shortcomings, a method is employed to select a predetermined menu or control execution of a predetermined application program when the user provides a two-dimensional gesture such as a line, curve, figure, sign, etc. Also, a touch input method is employed to perform an input operation by simply touching a menu or button displayed on a touch screen.

Korean Patent Application Laid-Open No. 2007-05583 entitled “Method and Apparatus for Producing One-Dimensional Signals with a Two-Dimensional Pointing Device” discloses a technique of generating one-dimensional inputs such as scrolling and the like by recognizing the trace of a two-dimensional gesture input by a user on a touch screen.

However, since a chirality-sensing function, accumulation function, extraction function, and ballistics function are used in the invention of Korean Patent Application Laid-Open No. 2007-05583, processing is complex and places a heavy load on a portable device. This may reduce recognition accuracy.

### SUMMARY OF THE INVENTION

The present invention provides a touch input recognition method that can increase the accuracy of the recognition of a touch input from a user and reduce a processing load in recognizing the touch input.

The present invention also provides a touch input recognition apparatus that can increase the accuracy of the recognition of a touch input from a user and reduce a processing load in recognizing the touch input.

In example embodiments, a touch input recognition method includes: receiving at least one coordinate value corresponding to a touch trace at a given time interval; determining an inflection point based on the received at least one coordinate value; setting, when a predetermined coordinate value of the at least one coordinate value is a coordinate value of the inflection point, a symbol value based on an increment/decrement feature of at least one coordinate value provided before the predetermined coordinate value; and retrieving an event corresponding to the set symbol value. The determining the inflection point based on the received at least one coordinate value may include: determining, when increment/decrement features of first and second coordinate values sequentially received at the given time interval are different from each other, the first coordinate value as the coordinate value of the inflection point. The setting, when the predetermined coordinate value of the at least one coordinate value is the coordinate value of the inflection point, the symbol value based on the increment/decrement feature of the at least one coordinate value provided before the predetermined coordinate value may include: setting the symbol value based on the increment/decrement feature of the at least one coordinate value provided before the predetermined coordinate value among at least one symbol value preset to correspond to an increment/decrement feature of a coordinate value; and generating a symbol array based on the at least one set symbol value. The retrieving the event corresponding to the set symbol value may include: retrieving the set symbol value or the generated symbol array from a database pre-storing an event item to be executed for each of at least one symbol value or symbol array.

In other example embodiments, a touch input recognition method includes: receiving at least one coordinate value corresponding to a touch trace at a given time interval; acquiring an accumulated distance and the number of coordinate value inputs based on the received at least one coordinate value; determining an inflection point based on the received at least one coordinate value; setting, when a predetermined coordinate value of the at least one coordinate value is a coordinate value of the inflection point, a symbol value based on an increment/decrement feature of at least one coordinate value provided before the predetermined coordinate value; acquiring a speed proportion value based on the accumulated distance and the number of coordinate value inputs; and retrieving an event corresponding to the symbol value and the speed proportion value. The acquiring the accumulated distance and the number of coordinate value inputs based on the received at least one coordinate value may include: computing a difference value between two successively provided coordinate values among the at least one coordinate value and acquiring the accumulated distance by accumulating the computed difference value; and acquiring the number of coordinate value inputs by counting at least one input coordinate value. The determining the inflection point based on the received at least one coordinate value may include: determining, when increment/decrement features of first and second coordinate values sequentially received at the given time interval are different from each other, the first coordinate value as the coordinate value of the inflection point. The setting, when the predetermined coordinate value of the at least one coordinate value is the coordinate value of the inflection point, the symbol value based on the increment/decrement feature of the at least one coordinate value provided before the predetermined coordinate value may include: setting the symbol value based on the increment/decrement feature of the at least one coordinate value provided before the predetermined coordinate value among at least one symbol value preset to correspond to an increment/decrement feature of a coordinate value. The acquiring the speed proportion value based on the accumulated distance and the number of coordinate value inputs may include: acquiring the speed proportion value by computing the ratio of the accumulated distance to the number of coordinate value inputs. The retrieving the event corresponding to the symbol value and the speed proportion value may include: generating a symbol array based on the symbol value and the speed proportion value; and retrieving the symbol array from a database pre-storing an event item to be executed for each of symbol arrays configured with symbol values and speed proportion values.

In still other example embodiments, a touch input recognition method includes: receiving at least one coordinate value corresponding to a touch trace at a given time interval; determining an inflection point based on the received at least one coordinate value; setting, when a predetermined coordinate value of the at least one coordinate value is a coordinate value of the inflection point, a symbol value based on an increment/decrement feature of at least one coordinate value provided before the predetermined coordinate value; acquiring a length of the touch trace based on the at least one determined inflection point; and retrieving an event corresponding to the symbol value and the acquired touch trace length. The acquiring the length of the touch trace based on the at least one determined inflection point may include: computing a distance of each of two neighboring inflection points among the at least one determined inflection point; and acquiring the length of the touch trace by accumulating the computed distances of the two neighboring inflection points.

In yet other example embodiments, a touch input recognition method includes: receiving at least one coordinate value and a magnitude of a touch input corresponding to a touch trace; determining an inflection point based on the received at least one coordinate value; setting, when a predetermined coordinate value of the at least one coordinate value is a coordinate value of the inflection point, a first symbol value based on an increment/decrement feature of at least one coordinate value provided before the predetermined coordinate value; setting a second symbol value corresponding to the received touch input magnitude; and setting an execution event corresponding to the set first and second symbol values.

In yet other example embodiments, a touch input recognition apparatus includes: a touch input unit configured to provide at least one coordinate value corresponding to a touch trace at a given time interval; a storage configured to store at least one of at least one symbol value and a symbol array configured with the at least one symbol value, and an execution event list corresponding to each of the at least one symbol value and the symbol array; and a controller configured to receive the at least one coordinate value provided at the given time interval, determine an inflection point based on the received at least one coordinate value, set a symbol value based on an increment/decrement feature of a coordinate value provided between inflection points, and read an event corresponding to the set symbol value from the storage. When increment/decrement features of first and second coordinate values sequentially received from the touch unit at the given time interval are different from each other, the controller may determine the first coordinate value as a coordinate value of the inflection point. The controller may generate a symbol array based on at least one set symbol value, retrieve the generated symbol array from the storage, and read an event corresponding to the symbol value. The controller may acquire an accumulated distance between inflection points and the number of coordinate value inputs between the inflection points based on the received at least one coordinate value, and acquire a speed proportion value based on the accumulated distance and the number of coordinate value inputs. The controller may generate a symbol array configured with the symbol value and the speed proportion value and retrieve the generated symbol array from the storage. The controller may acquire the speed proportion value by computing the ratio of the accumulated distance to the number of coordinate value inputs.

In yet other example embodiments, a touch input recognition apparatus includes: a touch unit configured to provide at least one coordinate value and a magnitude of a touch input corresponding to a touch trace at a given time interval; a storage configured to store at least one of at least one symbol value and a symbol array configured with the at least one symbol value, and an execution event list corresponding to each of the at least one symbol value and the symbol array; and a controller configured to receive the at least one coordinate value and the touch input magnitude, determine an inflection point based on the received at least one coordinate value, set a symbol value based on an increment/decrement feature of a coordinate value and a touch input magnitude provided between inflection points, and read an event corresponding to the set symbol value from the storage.

### BRIEF DESCRIPTION OF THE DRAWINGS

The above and other objects, features and advantages of the present invention will become more apparent to those of ordinary skill in the art by describing in detail example embodiments thereof with reference to the attached drawings, in which:

FIGS. 1 and 2 are conceptual diagrams showing a touch input recognition process according to an example embodiment of the present invention;

FIG. 3 is a flowchart showing a touch input recognition process according to an example embodiment of the present invention;

FIGS. 4 and 5 are conceptual diagrams showing a touch input recognition process according to another example embodiment of the present invention;

FIG. 6 is a flowchart showing a touch input recognition process according to another example embodiment of the present invention;

FIG. 7 is a conceptual diagram showing a touch input recognition process according to another example embodiment of the present invention;

FIG. 8 is a flowchart showing a touch input recognition process according to another example embodiment of the present invention;

FIG. 9 is a conceptual diagram showing a touch input recognition process according to another example embodiment of the present invention; and

FIG. 10 is a block diagram showing a structure of a touch input recognition apparatus according to an example embodiment of the present invention.

### DETAILED DESCRIPTION OF EXAMPLE EMBODIMENTS

Since a variety of permutations and embodiments of the present invention are possible, certain example embodiments will be described with reference to the accompanying drawings.

However, the example embodiments by no means restrict the scope of the present invention, which shall be construed as including all permutations, equivalents, and substitutes within the scope of the appended claims.

Terms such as “first” and “second” may be used to denote various elements but not to restrict them in any way. Such terms are used only to distinguish one element from another. For instance, the labels of first element and second element could be exchanged without departing from the scope of claims of the present invention. The term “and/or” shall mean a combination of items or any one of them.

When an element is described as being “connected to” or “contacting” another element, it shall be construed as being connected to contacting the other element directly or possibly having another element therebetween. On the other hand, if one element is described as being “directly connected to” or “directly contacting” another element, it means there is no other element therebetween.

The terms used in the description are intended to describe certain example embodiments only and by no means restrict the scope of the present invention. Unless clearly stated otherwise, elements referred to in the singular may be included in plural. In the present description, terms such as “comprising” and “including” with regard to a characteristic, number, step, operation, element, part, or combinations thereof shall not be construed as excluding the possible presence of one or more additional characteristics, numbers, steps, operations, elements, parts, or combinations thereof.

Unless stated otherwise, all terms used herein, including technical terms and scientific terms, are to be understood as having the same meaning as is understood by those of ordinary skill in the art to which the invention pertains. Any term that is defined in a general dictionary shall be construed to have the meaning given in the dictionary in the context of the relevant art, and, unless explicitly stated otherwise, shall not be interpreted to have any invented or excessively formal meaning.

Hereinafter, example embodiments of the present invention will be described in detail with reference to the accompanying drawings. Throughout the drawings, like elements are denoted by like reference numerals and will only be described once.

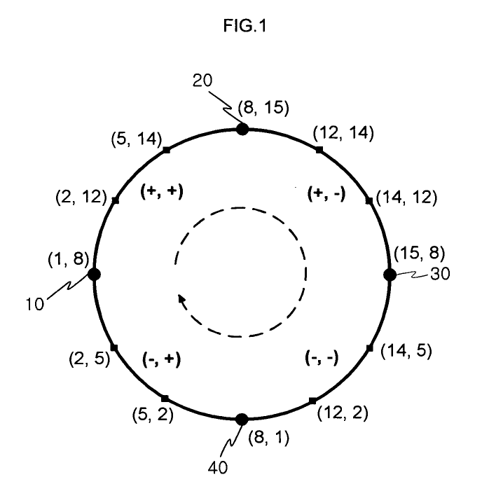

FIGS. 1 and 2 are conceptual diagrams showing a touch input recognition process according to an example embodiment of the present invention. FIG. 1 shows a touch input recognition process when a user draws a circle in the clockwise direction on a touch interface such as touch screen or touch pad.

Referring to FIG. 1, when the user draws a circle in the clockwise direction starting from a first inflection point 10, the touch screen or the touch pad provides a coordinate value (X, Y) corresponding to a trace (that is, a circular trace) of the user's touch at a given time interval. Here, the given time interval can differ according to the touch screen, and, for example, may be 20 ms.

For example, as shown in FIG. 1, when the user draws the circle in the clockwise direction with respect to the first inflection point 10, the touch screen can sequentially provide coordinate values (1, 8), (2, 12), (5, 14), and (8, 15) every 20 ms starting from the coordinate value (1, 8) of the first inflection point 10, and the provided coordinate values are used to determine increment/decrement features of coordinate values between inflection points.

In the increment/decrement features of the coordinate values between the inflection points in an example embodiment of the present invention, it is assumed that ‘+’ is set when the X or Y value of a predetermined coordinate value is greater than that of a previous coordinate value, ‘−’ is set when the X or Y value of the predetermined coordinate value is less than that of the previous coordinate value, and ‘0’ is set when the X or Y value of the predetermined coordinate value is equal to that of the previous coordinate value.

Among coordinate values provided from the first inflection point 10 to a second inflection point 20, both the X and Y values of a predetermined coordinate value (for example, (5, 14)) are greater than those of a previous coordinate value (for example, (2, 12)), such that the increment/decrement feature between the first inflection point 10 and the second inflection point 20 is (+, +).

When increment/decrement features between inflection points are determined by the method described above, increment/decrement features of coordinate values input between the second inflection point 20 and a third inflection point 30 are (+, −) since the X value of a predetermined coordinate value is greater than that of a previous coordinate value and the Y value of the predetermined coordinate value is less than that of the previous coordinate value.

Increment/decrement features of coordinate values input between the third inflection point 30 and a fourth inflection point 40 are (−, −) since the X and Y values of a predetermined coordinate value are less than those of a previous coordinate value.

Increment/decrement features of coordinate values input between the fourth inflection point 40 and the first inflection point 10 are (−, +) since the X value of a predetermined coordinate value is less than that of a previous coordinate value and the Y value is incremented.

As a result, when the user draws the circle in the clockwise direction from the beginning of the first inflection point 10 as shown in FIG. 1, the increment/decrement features between the inflection points obtained based on the coordinate values provided at the given time interval (for example, 20 ms) from the touch screen become (+, +), (+, −), (−, −), and (−, +). The above-described increment/decrement features can be replaced with preset symbol values and stored in an array.

In an example embodiment of the present invention, the increment/decrement feature of a coordinate value (X, Y) between inflection points can be one of (+, +), (+, −), (+, 0), (−, +), (−, −), (−, 0), (0, +), (0, −), and (0, 0). For example, the above-described increment/decrement features can be respectively symbolized to symbol values A, B, C, D, E, F, G, H, and I.

For example, the increment/decrement features of the coordinate values between the inflection points corresponding to the circular touch trace shown in FIG. 1 are (+, +), (+, −), (−, −), and (−, +), and the symbol values corresponding thereto are A, B, E, and D. Here, the symbol values can be stored in the form of an array [A, B, E, D].

A touch screen recognition apparatus having the touch screen retrieves the symbol array acquired along the touch trace from a database stored in a storage and executes an event corresponding to the symbol array, thereby recognizing the touch input provided by the user and executing the event corresponding to the recognized touch input.

In an example embodiment of the present invention, the inflection point is a point at which an increment/decrement feature of any one of the X and Y values varies. For example, when a coordinate value provided before the second inflection point 20 is (5, 14), a coordinate value of the second inflection point 20 is (8, 15), and a coordinate value provided after the second inflection point 20 is (12, 14) in FIG. 1, the increment/decrement feature based on the second inflection point 20 varies from (+, +) to (+, −), and hence the coordinate value (8, 15) becomes the inflection point.

Since a touch input type is determined based on an increment/decrement feature of a coordinate value between inflection points in the touch input recognition method according to the example embodiment of the present invention described above, a touch input order and/or direction as well as the touch input type can be determined.

That is, since the increment/decrement features differ according to the touch input order and/or direction when the same type of touch input is provided, the touch input order and/or direction can be distinguished. Thus, execution events can be assigned such that a variety of events can be executed for the same type of touch input.

FIG. 2 shows a touch input recognition process when the user draws a rectangle in the clockwise direction on the touch screen.

Referring to FIG. 2, when the user draws the rectangle in the clockwise direction starting from a first inflection point 11, the touch screen provides a coordinate value (X, Y) corresponding to a trace (that is, a rectangular trace) of the user's touch at a given time interval (for example, 20 ms).

For example, as shown in FIG. 2, when the user draws the rectangle in the clockwise direction with respect to the first inflection point 11, the touch screen can sequentially provide coordinate values (1, 1), (1, 3), (1, 5), and (1, 7) every 20 ms from the first inflection point 11 to a second inflection point 21, and increment/decrement features of coordinate values between inflection points are determined based on the provided coordinate values.

The increment/decrement features of coordinate values (X, Y) from the first inflection point 11 to the second inflection point 21 become (0, +) since the X value of a predetermined coordinate value (for example, (1, 5)) is the same as that of a previous coordinate value (for example, (1, 3)), and the Y value is incremented.

Since it is difficult for the user to draw a full vertical or horizontal line, it can be determined that a coordinate value has not varied when the coordinate value varies within a preset range.

When the increment/decrement features between inflection points are determined by the method described above, increment/decrement features of coordinate values input between the second inflection point 21 and a third inflection point 31 become (+, 0), increment/decrement features of coordinate values input between the third inflection point 31 and a fourth inflection point 41 become (0, −), and increment/decrement features of coordinate values input between the fourth inflection point 41 and the first inflection point 11 become (−, 0).

As a result, when the user draws the rectangle in the clockwise direction from the beginning of the first inflection point 11 as shown in FIG. 2, the increment/decrement features between the inflection points obtained based on coordinate values provided from the touch screen at the given time interval (for example, 20 ms) become (0, +), (+, 0), (0, −), and (−, 0), and are symbolized to preset symbol values G, C, H, and F.

When the user draws the rectangle in the counter-clockwise direction with respect to the first inflection point 11 in FIG. 2, increment/decrement features of coordinate values between inflection points become (+, 0), (0, +), (−, 0), and (0, −), and symbol values corresponding thereto become C, G, F, and H.

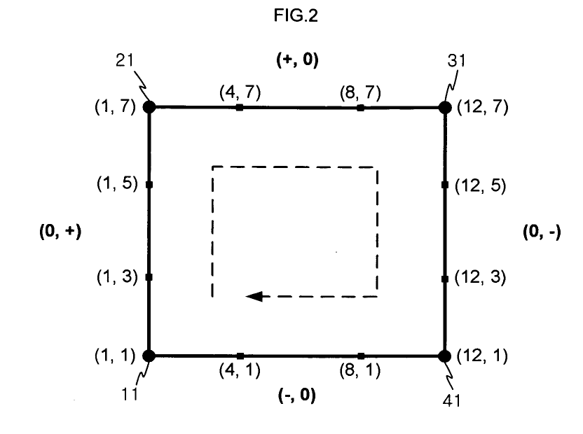

FIG. 3 is a flowchart showing a touch input recognition process according to an example embodiment of the present invention.

First, when an apparatus having the touch screen, that is, the touch input recognition apparatus, is powered on, a symbol array value j is initialized (that is, j=0) (step 101).

Then, when the user provides a predetermined touch input on the touch screen, the touch screen provides a coordinate value (X, Y) corresponding to a touch trace at a preset time interval (for example, 20 ms) (step 103).

The touch input recognition apparatus compares two successively inputting coordinate values among coordinate values sequentially provided from the touch screen and determines an increment/decrement feature of the coordinate values (step 105).

The touch input recognition apparatus determines an inflection point based on the increment/decrement feature of the provided coordinate values (step 107). When a predetermined coordinate value among the provided coordinate values is determined as the inflection point, a symbol value corresponding to an increment/decrement feature of a coordinate value provided before the inflection point is set among preset symbol values corresponding to increment/decrement features of coordinate values (step 109).

In step 107, when increment/decrement features of first and second coordinates sequentially provided from the touch screen are different from each other, the touch input recognition apparatus can determine the first coordinate value as a coordinate value of the inflection point.

Then, the touch input recognition apparatus generates a symbol array configured with set symbol values of step 109 (step 111), and increments a symbol array value j (that is, j=j++) (step 113).

The touch input recognition apparatus searches for a symbol array that is the same as the generated symbol array in the pre-stored database and determines whether the symbol array is stored in the database (step 117).

Here, the touch input recognition apparatus can have, in advance, the database storing at least one symbol array, and a touch input type corresponding to each of the at least one symbol array and/or an execution event list corresponding thereto. An execution event indicates operation content of the touch input recognition apparatus to be executed in correspondence with a type of touch input by the user, touch speed, or touch input magnitude.

Upon determining that the symbol array is stored in the database in step 117, the touch input recognition apparatus can determine whether an execution event corresponding to the symbol array can be set (step 119).

Upon determining that the execution event corresponding to the symbol array can be set in step 119, the event corresponding to the symbol array is executed (step 121).

Upon determining that the set symbol array is not stored in the database in step 117 or that the execution event corresponding to the symbol array cannot be set in step 119, the touch input recognition apparatus returns to step 103 to sequentially perform subsequent steps.

For example, when a symbol array set in a predetermined time is configured with [A, B] and at least two symbol arrays including the symbol array [A, B] are stored in the database, the execution event corresponding to the symbol array [A, B] cannot be set. Until the execution event corresponding to the set symbol array can be set, steps 103 to 119 are repeated, thereby incrementing the number of symbol values to be included in the symbol array.

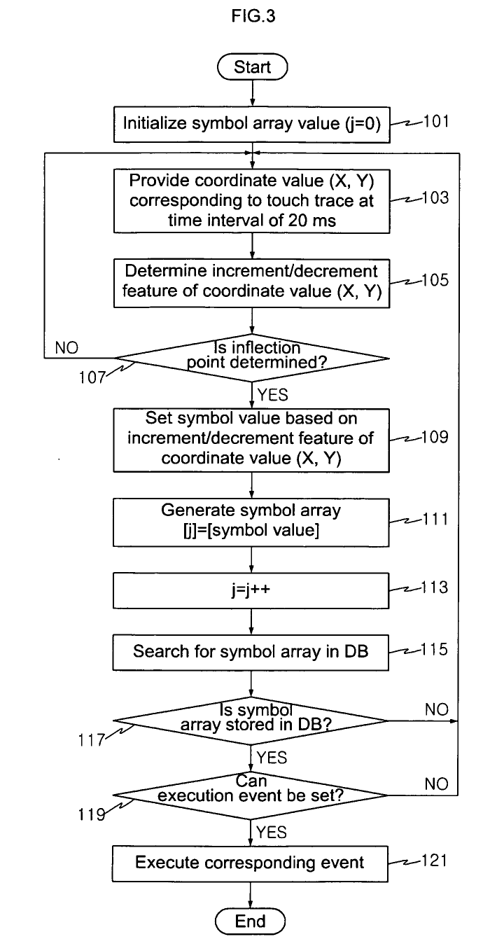

FIGS. 4 and 5 are conceptual diagrams showing a touch input recognition process according to another example embodiment of the present invention. FIG. 4 shows the touch input recognition process when the user draws the rectangle in the clockwise direction on the touch screen, and FIG. 5 shows a graph of an increment/decrement feature and touch speed for a coordinate value of the rectangle shown in FIG. 4.

Referring to FIGS. 4 and 5, when the user draws the rectangle in the clockwise direction starting from a first inflection point 12, the touch screen provides a coordinate value (X, Y) corresponding to a rectangular trace of the user's touch at a given time interval (for example, 20 ms).

The touch input recognition apparatus determines an increment/decrement feature corresponding to a trace between inflection points based on coordinate values provided by the touch screen, and symbolizes the determined increment/decrement feature to a corresponding symbol value.

In FIG. 4, increment/decrement features of coordinate values between determined inflection points are (0, +), (+, 0), (0, −), and (−, 0), and symbol values given by symbolizing the increment/decrement features become G, C, H, and F.

According to another example embodiment of the present invention, the touch input recognition apparatus determines an increment/decrement feature of a coordinate value provided from the touch screen as described above and simultaneously computes a speed proportion value to determine touch speed input by the user.

Specifically, the touch input recognition apparatus acquires the speed proportion value by computing the ratio of a distance between inflection points to the number of coordinate values input between the inflection points (Distance between inflection points/Number of input coordinate values).

For example, as shown in FIG. 4, when a distance (Y-value difference) between the first inflection point 12 and a second inflection point 22 is 6 and three coordinate values are input therebetween, the speed proportion value becomes 2. When a distance (X-value difference) between the second inflection point 22 and a third inflection point 32 is 10 and six coordinate values are input therebetween, the speed proportion value becomes 1.6. In the same method, the speed proportion value between the third inflection point 32 and a fourth inflection point 42 becomes 1.5 and the speed proportion value between the fourth inflection point 42 and the first inflection point 12 becomes 2.5.

Then, the touch input recognition apparatus generates a symbol array based on symbol values acquired from increment/decrement features of coordinate values input between inflection points and speed proportion values between the inflection points as described above.

For example, the symbol array for the rectangle shown in FIG. 4 can be [(G, 2), (C, 2), (H, 2), (F, 3)], and the symbol array can be expressed by the graph shown in FIG. 4. Here, it is assumed that the speed proportion value is rounded off to the nearest integer.

Then, the touch input recognition apparatus retrieves the symbol array based on the symbol values corresponding to the increment/decrement features of the input coordinate values and the speed proportion values from the database and executes an event corresponding to the retrieved symbol array.

In the touch input recognition method according to another example embodiment of the present invention shown in FIGS. 4 and 5, an execution event is set by simultaneously considering a type of touch input by the user using the touch screen and touch speed, such that a variety of sub-divided events can be executed.

For example, when given graphic information is displayed on a display region of the touch screen and the user draws a circle at a first speed on the touch screen, currently displayed graphic information can be configured to be enlarged by a first magnification. When the user draws the circle at a second speed that is higher than the first speed, the graphic information can be configured to be enlarged by a second magnification that is greater than the first magnification.

When a given document is displayed on a display region of the touch screen, scroll speed of the displayed document varies in proportion to speed at which the user draws the rectangle.

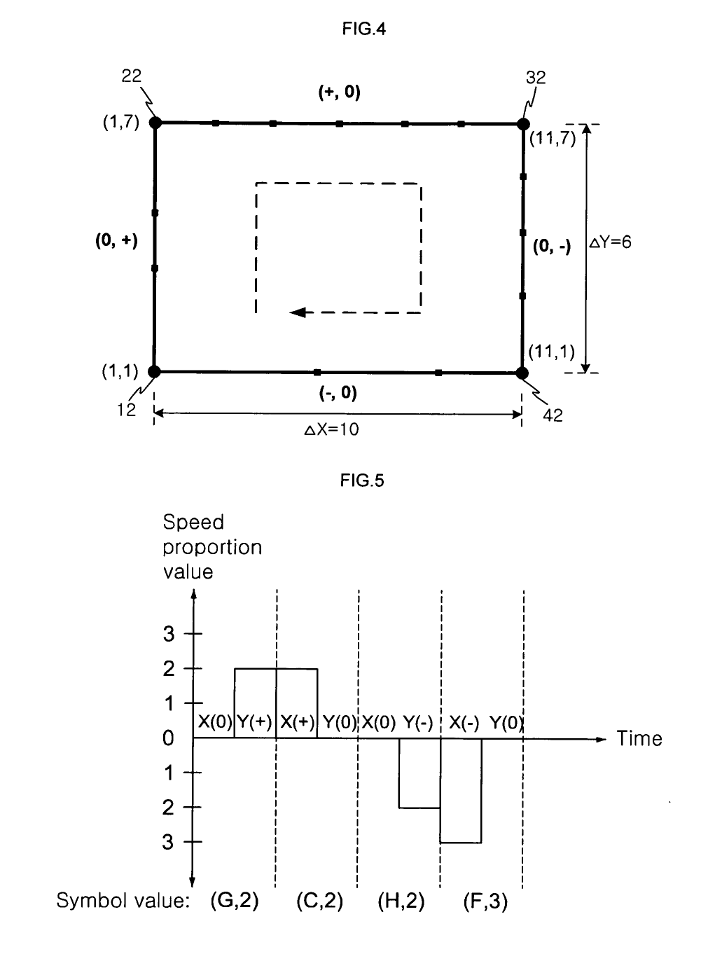

FIG. 6 is a flowchart showing a touch input recognition process according to another example embodiment of the present invention.

First, when the touch input recognition apparatus having the touch screen is powered on, the number i of coordinate value inputs and a symbol array value j are initialized (that is, i=0 and j=0) (step 201).

Then, when the user provides a predetermined touch input on the touch screen, the touch screen provides a coordinate value (X, Y) corresponding to a touch trace at a preset time interval (for example, 20 ms) (step 203).

When the coordinate value (X, Y) is input from the touch screen, the touch input recognition apparatus increments the number i of coordinate value inputs (that is, i=i++) (step 205).

The touch input recognition apparatus computes an accumulated distance based on provided coordinate values (step 207).

Here, the touch input recognition apparatus can compute the accumulated distance by various methods. For example, when there is no X or Y value variation between two coordinate values sequentially provided, a difference between varied coordinate values is computed. The accumulated distance can be computed by adding distance values, computed by the same method, for successively inputting coordinate values.

When there are both X and Y value variations between two coordinate values sequentially provided, a distance between the two coordinate values is computed by averaging X and Y value differences. The accumulated distance can be computed by adding distance values, computed by the same method, for successively inputting coordinate values.

The touch input recognition apparatus determines an increment/decrement feature of coordinate values by comparing two coordinate values successively input among coordinate values sequentially provided from the touch screen (step 209).

The touch input recognition apparatus determines an inflection point based on the increment/decrement feature of the provided coordinate values (step 211). When a predetermined coordinate value of the provided coordinate values is determined as the inflection point, a symbol value corresponding to an increment/decrement feature of a coordinate value provided before the inflection point is set among preset symbol values corresponding to increment/decrement features, and a speed proportion value is acquired (step 213).

Upon determining that the predetermined coordinate value is not the inflection point in step 211, the touch input recognition apparatus returns to step 203 and repeats steps 203 to 211.

In step 213, the touch input recognition apparatus acquires the speed proportion value by computing the ratio of the distance between inflection points computed in step 207 to the number of coordinate values acquired in step 205 (that is, Speed proportion value=Distance between inflection points/Number of input coordinate values).

Then, the touch input recognition apparatus generates a symbol array configured with the symbol value and the speed proportion value acquired in step 213 (step 215), and then resets the number i of coordinate value inputs and increments the symbol array value j (that is, j=j++) (step 217).

Then, the touch input recognition apparatus searches for the generated symbol array of step 215 in the pre-stored database (step 219) and determines whether the symbol array is stored in the database (step 221).

Here, the touch input recognition apparatus can have, in advance, the database storing at least one symbol array configured with a symbol value and a speed proportion value, and a touch input type corresponding to each of the at least one symbol array and/or an execution event list corresponding thereto.

Upon determining that the symbol array is stored in the database in step 221, the touch input recognition apparatus can determine whether an execution event corresponding to the symbol array can be set (step 223). Upon determining that the execution event corresponding to the symbol array can be set, the event corresponding to the symbol array is executed (step 225).

Upon determining that the symbol array is not stored in the database in step 221, or that the execution event corresponding to the symbol array cannot be set in step 223, the touch input recognition apparatus returns to step 203 and repeats steps 203 to 223 until the execution event corresponding to the touch input by the user can be set.

In another example embodiment of the present invention, the number of iterations of steps 203 to 223 is counted. When the count is equal to or greater than a preset value, an error message can be configured to be displayed on a display region of the touch screen.

In another example embodiment of the present invention, when the user provides a predetermined type of touch input on the touch screen, a coordinate value (X, Y) of a touch trace and a touch input magnitude Z are simultaneously received. A process of setting an execution event by simultaneously considering the touch input type and the touch input magnitude is provided.

Specifically, the touch input recognition apparatus can divide the touch input magnitude into two types by setting a predetermined reference value for the touch input magnitude and comparing the touch input magnitude Z provided from the touch screen with the reference value. The divided touch input magnitudes can be symbolized according to a predefined symbolization method.

For example, when the touch input magnitude Z provided from the touch screen is less than the reference value, it can be denoted by ‘1’ (that is, Z=1). When the touch input magnitude Z provided from the touch screen is equal to or greater than the reference value, it can be denoted by ‘2’ (that is, Z=2).

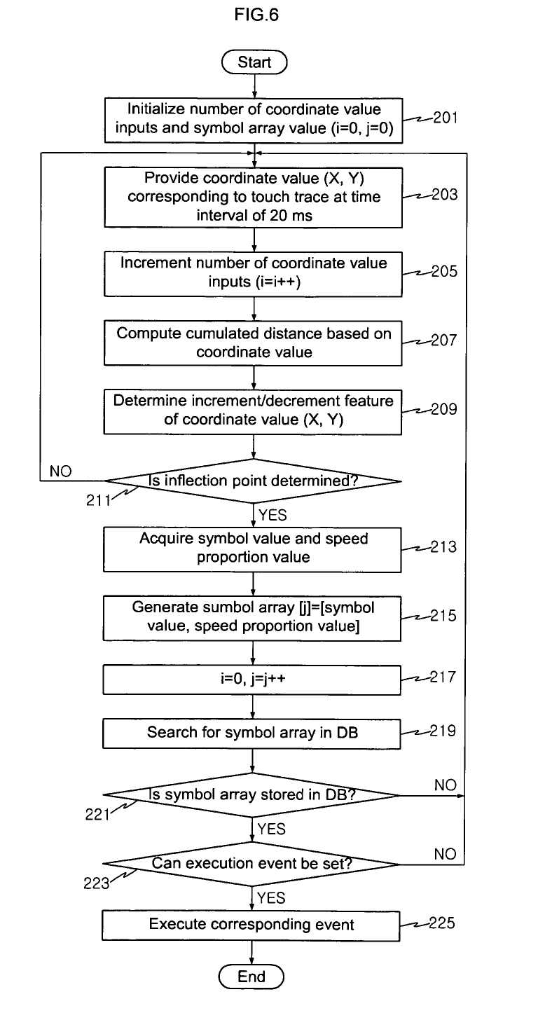

FIG. 7 is a conceptual diagram showing a touch input recognition process according to another example embodiment of the present invention. FIG. 7 shows a touch input recognition process based on a coordinate value (X, Y) and a touch input magnitude Z provided from the touch screen when the user draws a circle on the touch screen.

The coordinate value (X, Y) and the touch input magnitude Z provided from the touch screen can be simultaneously displayed in the graph, as shown in FIG. 7, corresponding to the touch input of the user. An increment/decrement feature of coordinate values between inflection points can be symbolized to a preset symbol value, and, simultaneously, the touch input magnitude can be symbolized to a corresponding symbol value according to a predefined symbolization method.

The touch input recognition apparatus generates a symbol array from the symbol value for the increment/decrement feature between inflection points and the symbol value for the touch input magnitude, and then executes a corresponding event by recognizing the touch input type and the touch input magnitude through the generated symbol array.

For example, when coordinate values (X, Y) and touch input magnitudes Z provided from the touch screen are the same as shown in FIG. 7, a symbol array configured with symbol values of increment/decrement features between inflection points and touch input magnitudes becomes [(A, 1), (B, 1), (E, 2), (D, 2)].

The touch input recognition apparatus can set an execution event corresponding to the symbol array by retrieving a symbol array that is the same as the generated symbol array [(A, 1), (B, 1), (E, 2), (D, 2)] from the database.

For example, when the touch input type corresponding to the symbol array retrieved from the database is a circle traced in the clockwise direction, the touch input recognition apparatus can determine that the touch input magnitude of a portion of the circle (that is, a portion from a third inflection point 30 to a first inflection point 10 going through a fourth inflection point 40) is greater than a preset reference value, and can execute a corresponding event.

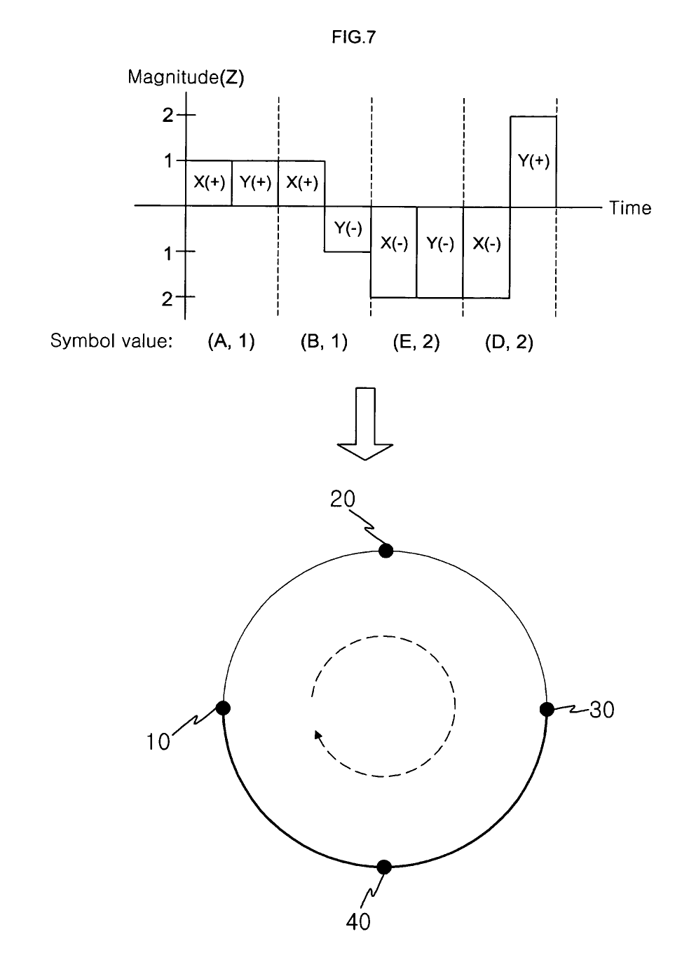

FIG. 8 is a flowchart showing a touch input recognition process according to another example embodiment of the present invention.

Referring to FIG. 8, when the touch input recognition apparatus having the touch screen is powered on, a symbol array value j is initialized (that is, j=0) (step 301).

Then, when the user provides a predetermined touch input on the touch screen, the touch screen provides a coordinate value (X, Y) and a touch input magnitude Z corresponding to a touch trace at a preset time interval (for example, 20 ms) (step 303).

Here, the touch input magnitude Z can be touch pressure magnitude when the touch screen is a pressure resistive type, and capacitance variation when the touch screen is a capacitive type.

Then, the touch input recognition apparatus determines an increment/decrement feature of coordinate values by comparing two coordinate values successively input among coordinate values sequentially provided (step 305).

Then, the touch input recognition apparatus determines an inflection point based on the increment/decrement feature of the provided coordinate values (step 307). When a predetermined coordinate value of the provided coordinate values is determined as the inflection point, a symbol value corresponding to an increment/decrement feature of a coordinate value provided before the inflection point is set among preset symbol values corresponding to increment/decrement features (step 309).

Then, the touch input recognition apparatus compares the provided touch input magnitude Z with a preset reference value and sets a symbol value corresponding to the touch input magnitude (step 311).

Upon determining that the predetermined coordinate value is not the inflection point in step 307, the touch input recognition apparatus returns to step 303 and repeats steps 303 to 311.

The order of steps 309 and 311 can be permutated or they can be performed simultaneously.

In the symbolization process of the touch input magnitude to be performed in step 311, one touch input can be symbolized by various methods according to the number of execution events corresponding thereto.

For example, when the touch input magnitude is symbolized to two symbol values, one reference value is set and compared with the touch input magnitude Z. When the touch input magnitude Z is less than the reference value, a first symbol value (for example, 1) can be set. When the touch input magnitude Z is greater than the reference value, a second symbol value (for example, 2) can be set.

When the touch input magnitude is symbolized to three symbol values, first and second reference values are set and compared with the touch input magnitude Z. When the touch input magnitude Z is less than the first reference value, a first symbol value (for example, 1) can be set. When the touch input magnitude Z corresponds to a value between the first and second reference values, a second symbol value (for example, 2) can be set. When the touch input magnitude Z is greater than the second reference value, a third symbol value (for example, 3) can be set.

Then, the touch input recognition apparatus generates a symbol array configured with the symbol values corresponding to the input coordinate value and the touch input magnitude set in steps 309 and 311 (step 313), and then increments a symbol array value j (that is, j=j++) (step 315).

Then, the touch input recognition apparatus searches for a symbol array that is the same as the generated symbol array of step 313 in the pre-stored database (step 317) and determines whether the symbol array is stored in the database (step 319).

Here, the touch input recognition apparatus can have the database storing various types of symbol arrays, a touch input type corresponding to each symbol array, execution event information, and the like.

Upon determining that the symbol array is stored in the database in step 319, the touch input recognition apparatus determines whether an execution event corresponding to the symbol array can be set (step 321). Upon determining that the execution event corresponding to the symbol array can be set, the event corresponding to the symbol array is executed (step 323).

Upon determining that the symbol array is not stored in the database in step 319, or that the execution event corresponding to the symbol array cannot be set in step 321, the touch input recognition apparatus returns to step 303 and repeats steps 303 to 321 until the execution event corresponding to the touch input by the user can be set.

In the touch input recognition method shown in FIG. 8, an example of generating a symbol array after symbolizing a touch input magnitude Z provided from the touch screen to a preset symbol value has been described. Another example embodiment of the present invention can be configured to execute a given event in proportion to the provided touch input magnitude Z without symbolizing the touch input magnitude Z provided from the touch screen.

For example, when the user draws a circle in the clockwise direction on the touch screen, graphic information displayed on the touch screen can be scrolled in an upward direction, and, simultaneously, scroll speed can vary in proportion to the touch input magnitude.

When the user draws a circle in the counter-clockwise direction on the touch screen, graphic information displayed on the touch screen can be scrolled in a downward direction, and, simultaneously, scroll speed can vary in proportion to the touch input magnitude.

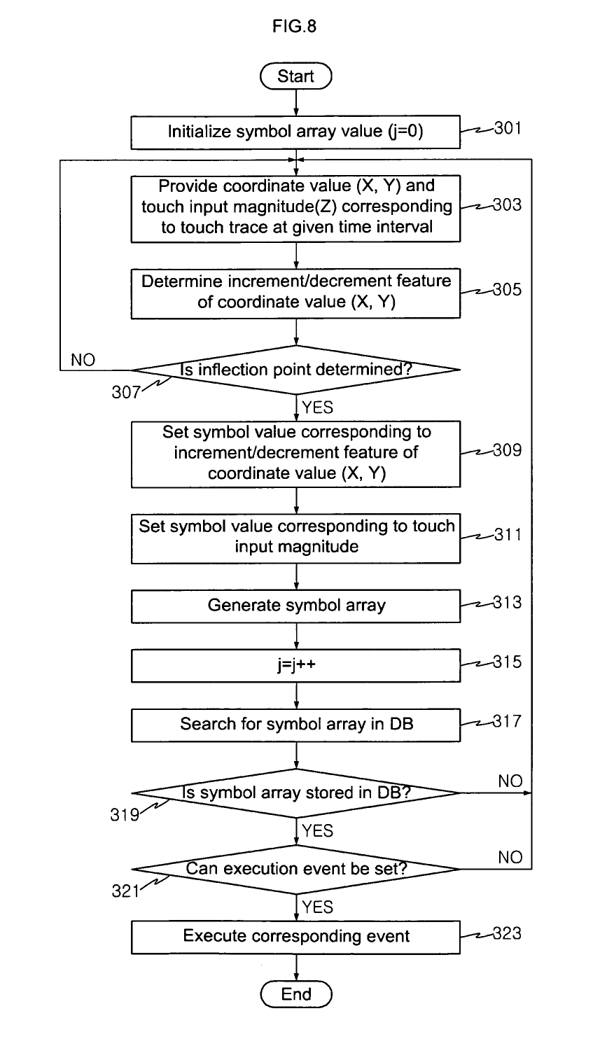

FIG. 9 is a conceptual diagram showing a touch input recognition process according to another example embodiment of the present invention. FIG. 9 shows a touch input recognition process when the user draws a spiral of a predetermined length in the clockwise direction on the touch screen.

Referring to FIG. 9, when the user draws the spiral in the clockwise direction starting from a predetermined position 50, the touch screen provides a coordinate value (X, Y) corresponding to a spiral trace of the user's touch at a given time interval.

The touch input recognition apparatus determines inflection points 51 to 60 based on increment/decrement features of coordinate values provided from the touch screen and symbolizes the increment/decrement features between the determined inflection points of the spiral trace to symbol values.

For example, in the case of the spiral shown in FIG. 5, the increment/decrement features between the inflection points 51 to 60 from the position 50 at which the spiral starts become (−, +), (+, +), (+, −), (−, −), (−, +), (+, +), (+, −), (−, −), (−, +), (+, +), and (+, −). When the increment/decrement features are converted into the symbol values, the symbol values are D, A, B, E, D, A, B, E, D, A, and B.

Then, the touch input recognition apparatus determines that the type of touch input by the user is the clockwise spiral by retrieving a symbol array [D, A, B, E, D, A, B, E, D, A, B] configured with the above-described symbol values from the database.

When the above-described inflection points are determined, the touch input recognition apparatus computes a total spiral length (that is, a+b+c+d+e+f+g+h+i+j+k) by computing and sequentially accumulating distances a, b, c, d, e, f, g, h, i, j, and k between neighboring inflection points.

The touch input recognition apparatus retrieves an execution event corresponding to the symbol array and the total spiral length set as described above from the database, and sets and executes the event. Here, the touch input recognition apparatus can be configured to compute straight-line distances between neighboring inflection points as shown in FIG. 5, in order to simplify the computation, and compute the total spiral length by accumulating the computed straight-line distances.

When the user draws a circle or rectangle on the touch screen, the touch input recognition apparatus can be configured to compute an area of the circle or rectangle and set an execution event based on a symbol value corresponding to the computed area and the increment/decrement feature corresponding to the touch trace.

In another example embodiment of the present invention shown in FIG. 9, since a touch input is recognized by simultaneously considering an increment/decrement feature of the touch input and a length or area thereof, and a corresponding event is executed, a variety of sub-divided events can be executed by one touch input.

For example, when the execution event corresponding to the spiral drawn in the clockwise direction on the touch screen is set to the enlargement of graphic information, and the execution event corresponding to the spiral drawn in the counter-clockwise direction on the touch screen is set to the reduction of graphic information, the degree of enlargement (magnification) of graphic information can vary in proportion to the length of the clockwise spiral, and the degree of reduction (demagnification) of graphic information can vary in proportion to the length of the counter-clockwise spiral.

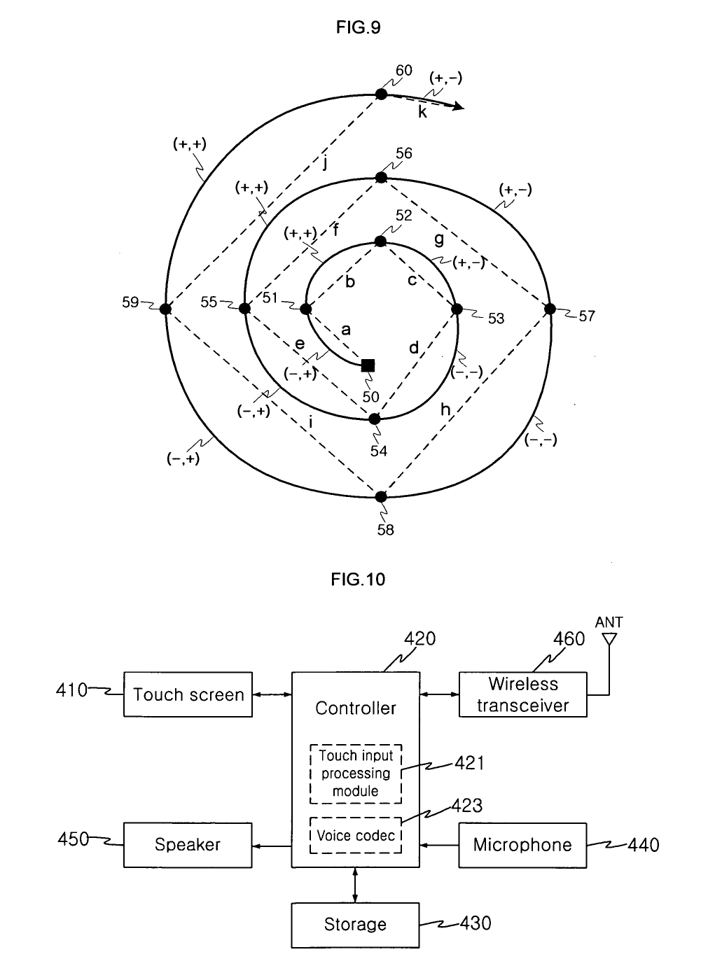

FIG. 10 is a block diagram showing a structure of a touch input recognition apparatus according to an example embodiment of the present invention. FIG. 10 shows an example of a portable device having a touch screen as the touch input recognition apparatus.

Referring to FIG. 10, the portable device according to an example embodiment of the present invention, which performs the touch input recognition method, can include a touch input unit 410, a controller 420, a storage 430, a microphone 440, a speaker 450, and a wireless transceiver 460.

The touch input unit 410 may be one of a touch screen and a touch pad. Hereinafter, it is assumed that the touch input unit 410 is a touch screen.

The touch screen 410 can be configured as a pressure resistive touch screen or a capacitive touch screen. When the touch screen 410 is the pressure resistive touch screen, a coordinate value (X, Y) corresponding to a touch trace and touched pressure magnitude are provided to the controller 420. When the touch screen 410 is the capacitive touch screen, a coordinate value (X, Y) corresponding to the touch trace and capacitance variation corresponding to the touch input are provided to the controller 420.

When the touch input is provided in a two-dimensional figure such as a rectangle, circle, line, or the like, the touch screen 410 can provide the controller 420 with a coordinate value at a predetermined position of the touch trace at a given time interval (for example, 20 ms).

Under control of the controller 420, the touch screen 410 displays a graphical interface screen such as a menu of a portable device, an execution screen of an executed application program, or the like.

When coordinate values (X, Y) are received from the touch screen 410 at the given time interval, the controller 420 determines an increment/decrement feature of coordinate values by comparing two successively input coordinate values, and determines an inflection point based on the determined increment/decrement feature.

When a predetermined coordinate value is determined as the inflection point, the controller 420 sets a symbol value corresponding to an increment/decrement feature of a coordinate value provided before the inflection point and generates a symbol array configured with set symbol values based on increment/decrement features of coordinate values provided between inflection points.

Then, the controller 420 executes an operation corresponding to the touch input from the user by retrieving a symbol array that is the same as the generated symbol array from the database stored in the storage 430 and setting and executing an event corresponding to the symbol array.

The controller 420 determines inflection points based on coordinate values (X, Y) provided from the touch screen at the given time interval, determines increment/decrement features of coordinate values between the inflection points, and computes the number of coordinate value inputs and an accumulated distance between the inflection points.

The controller 420 sets symbol values corresponding to the determined increment/decrement features, computes speed proportion values based on the number of coordinate value inputs and the accumulated distance, and generates a symbol array configured with the symbol values and the speed proportion values.

Then, the controller 420 retrieves the symbol array configured with the symbols values and the speed proportion values from the database and sets and executes an event corresponding to the symbol array.

The controller 420 sets symbol values corresponding to a coordinate value (X, Y) and a touch input magnitude Z input from the touch screen by comparing the touch input magnitude Z with a given reference value.

Then, the controller 420 generates a symbol array configured with the symbol values corresponding to the input coordinate value and the touch input magnitude, retrieves a symbol array that is the same as the generated symbol array from the database pre-stored in the storage 430, and sets and executes an event corresponding to the type and magnitude of touch input.

The function of the controller 420 described above can be configured to be performed by a touch input processing module 421 that can be implemented by software or by a special semiconductor chip.

The controller 420 can include a voice codec 423 for processing transmission and reception voice data. The voice codec 423 receives voice of a user received from a microphone 440, converts the voice into a digital signal, encodes the digital signal based on a voice communication standard, and provides the signal to the wireless transceiver 460, such that the signal is transmitted to a counterpart portable device for voice communication.

The voice codec 423 decodes the voice of the other party provided from a counterpart portable device for voice communication through the wireless transceiver 460, converts the decoded voice into an analog signal, and provides the analog signal to the speaker 450.

The storage 430 can be configured with a non-volatile memory such as a flash memory, electrically erasable and programmable read only memory (EEPROM), or the like, and stores a database configured with at least one symbol array and a touch input type and/or execution event information corresponding to each of the at least one symbol array.

Upon voice communication, the microphone 440 receives voice of a user, that is, a caller, converts the voice into an electrical signal, and provides the electrical signal to the controller 420. The speaker 450 receives a decoded voice signal of the other party for voice communication from the voice codec 423 and outputs a signal in an audible frequency band.

Since the wireless transceiver 460 is well known, it is not shown in detail. The wireless transceiver 460 can include a duplexer, a radio frequency (RF) processor, and an intermediate frequency (IF) processor. The wireless transceiver 460 receives an RF signal picked up by an antenna ANT through the duplexer, converts the received RF signal into an IF signal, converts the IF signal into a baseband signal, and provides the baseband signal to the controller 420. The wireless transceiver 460 converts a baseband signal received from the controller 420 into an IF signal, converts the IF signal into an RF signal, and provides the RF signal to the antenna ANT through the duplexer.

The wireless transceiver 460 can use a direct conversion method of directly demodulating a received RF signal without frequency conversion, in place of a heterodyne reception method of demodulating the above-described RF signal into a baseband signal through conversion into an IF signal.

According to the touch input recognition method and apparatus described above, when a coordinate value corresponding to a trace of a user's touch is provided at a given time interval, an inflection point based on the received coordinate value is determined and an increment/decrement feature of the coordinate value is determined and symbolized into a symbol value. A speed proportion value is computed based on the number of coordinate value inputs and an accumulated distance between inflection points, a symbol array based on the symbol value and the speed proportion value is generated and retrieved from a database and an event corresponding to the retrieved symbol array is executed. When a coordinate value and a touch input magnitude corresponding to a trace of the user's touch are provided, a symbol array configured with a symbol value corresponding to the coordinate value and a symbol value corresponding to the touch input magnitude is generated and retrieved from a database, and an event corresponding to the retrieved symbol array is executed.

Accordingly, an event corresponding to a touch input by the user is retrieved and executed based on an increment/decrement feature of a coordinate value, thereby reducing a processing load and a false recognition rate.

Since an execution event is set by simultaneously considering a symbol value given by symbolizing a speed proportion value given by modeling touch speed by the user or touch input magnitude, and a symbol value given by symbolizing an increment/decrement feature of coordinate values sequentially input along a touch trace, a variety of sub-divided events can be executed by one touch input.

While the invention has been shown and described with reference to certain example embodiments thereof, it will be understood by those skilled in the art that various changes in form and details may be made therein without departing from the spirit and scope of the invention as defined by the appended claims.

What is claimed is:

1. A touch input recognition method comprising:
receiving at least one coordinate value corresponding to a touch trace at a given time interval;
determining an inflection point based on the received at least one coordinate value;
setting, when a predetermined coordinate value of the at least one coordinate value is a coordinate value of the inflection point, a symbol value based on an increment/decrement feature of at least one coordinate value provided before the predetermined coordinate value; and
retrieving an event corresponding to the set symbol value.

2. The touch input recognition method of claim 1, wherein the determining the inflection point based on the received at least one coordinate value comprises:
determining, when increment/decrement features of first and second coordinate values sequentially received at the given time interval are different from each other, the first coordinate value as the coordinate value of the inflection point.

3. The touch input recognition method of claim 1, wherein the setting, when the predetermined coordinate value of the at least one coordinate value is the coordinate value of the inflection point, the symbol value based on the increment/decrement feature of the at least one coordinate value provided before the predetermined coordinate value comprises:
setting the symbol value based on the increment/decrement feature of the at least one coordinate value provided before the predetermined coordinate value among at least one symbol value preset to correspond to an increment/decrement feature of a coordinate value; and
generating a symbol array based on the at least one set symbol value.

4. The touch input recognition method of claim 3, wherein the retrieving the event corresponding to the set symbol value comprises:
retrieving the set symbol value or the generated symbol array from a database pre-storing an event item to be executed for each of at least one symbol value or symbol array.

5. A touch input recognition method comprising:
receiving at least one coordinate value corresponding to a touch trace at a given time interval;
acquiring an accumulated distance and the number of coordinate value inputs based on the received at least one coordinate value;
determining an inflection point based on the received at least one coordinate value;
setting, when a predetermined coordinate value of the at least one coordinate value is a coordinate value of the inflection point, a symbol value based on an increment/decrement feature of at least one coordinate value provided before the predetermined coordinate value;
acquiring a speed proportion value based on the accumulated distance and the number of coordinate value inputs; and
retrieving an event corresponding to the symbol value and the speed proportion value.

6. The touch input recognition method of claim 5, wherein the acquiring the accumulated distance and the number of coordinate value inputs based on the received at least one coordinate value comprises:
computing a difference value between two successively provided coordinate values among the at least one coordinate value and acquiring the accumulated distance by accumulating the computed difference value; and
acquiring the number of coordinate value inputs by counting at least one input coordinate value.

7. The touch input recognition method of claim 5, wherein the determining the inflection point based on the received at least one coordinate value comprises:
determining, when increment/decrement features of first and second coordinate values sequentially received at the given time interval are different from each other, the first coordinate value as the coordinate value of the inflection point.

8. The touch input recognition method of claim 5, wherein the setting, when the predetermined coordinate value of the at least one coordinate value is the coordinate value of the inflection point, the symbol value based on the increment/decrement feature of the at least one coordinate value provided before the predetermined coordinate value comprises:
setting the symbol value based on the increment/decrement feature of the at least one coordinate value provided before the predetermined coordinate value among at least one symbol value preset to correspond to an increment/decrement feature of a coordinate value.

9. The touch input recognition method of claim 5, wherein the acquiring the speed proportion value based on the accumulated distance and the number of coordinate value inputs comprises:
acquiring the speed proportion value by computing the ratio of the accumulated distance to the number of coordinate value inputs.

10. The touch input recognition method of claim 5, wherein the retrieving the event corresponding to the symbol value and the speed proportion value comprises:
generating a symbol array based on the symbol value and the speed proportion value; and
retrieving the symbol array from a database pre-storing an event item to be executed for each of symbol arrays configured with symbol values and speed proportion values.

11. A touch input recognition method comprising:
receiving at least one coordinate value corresponding to a touch trace at a given time interval;
determining an inflection point based on the received at least one coordinate value;
setting, when a predetermined coordinate value of the at least one coordinate value is a coordinate value of the inflection point, a symbol value based on an increment/decrement feature of at least one coordinate value provided before the predetermined coordinate value;
acquiring a length of the touch trace based on the at least one determined inflection point; and
retrieving an event corresponding to the symbol value and the acquired touch trace length.

12. The touch input recognition method of claim 11, wherein the acquiring the length of the touch trace based on the at least one determined inflection point comprises:
computing a distance of each of two neighboring inflection points among the at least one determined inflection point; and
acquiring the length of the touch trace by accumulating the computed distances of the two neighboring inflection points.

13. A touch input recognition method comprising:
receiving at least one coordinate value and a magnitude of a touch input corresponding to a touch trace;
determining an inflection point based on the received at least one coordinate value;
setting, when a predetermined coordinate value of the at least one coordinate value is a coordinate value of the inflection point, a first symbol value based on an increment/decrement feature of at least one coordinate value provided before the predetermined coordinate value;
setting a second symbol value corresponding to the received touch input magnitude; and
setting an execution event corresponding to the set first and second symbol values.

14. The touch input recognition method of claim 13, wherein the determining the inflection point based on the received at least one coordinate value comprises:
determining, when increment/decrement features of first and second coordinate values sequentially received at a given time interval are different from each other, the first coordinate value as the coordinate value of the inflection point.

15. The touch input recognition method of claim 13, wherein the touch input magnitude includes at least one of touch pressure magnitude and capacitance variation corresponding to the touch input.

16. The touch input recognition method of claim 13, wherein the setting the second symbol value corresponding to the received touch input magnitude comprises:
setting the second symbol value based on a result of comparing the touch input magnitude with a preset reference value.

17. The touch input recognition method of claim 13, wherein the setting the execution event corresponding to the set first and second symbol values comprises:
generating a symbol array configured with the first and second symbol values; and
retrieving the generated symbol array from a database storing at least one symbol array and an execution event corresponding to each of the at least one symbol array.

18. A touch input recognition apparatus comprising:
a touch input unit configured to provide at least one coordinate value corresponding to a touch trace at a given time interval;
a storage configured to store at least one of at least one symbol value and a symbol array configured with the at least one symbol value, and an execution event list corresponding to each of the at least one symbol value and the symbol array; and
a controller configured to receive the at least one coordinate value provided at the given time interval, determine an inflection point based on the received at least one coordinate value, set a symbol value based on an increment/decrement feature of a coordinate value provided between inflection points, and read an event corresponding to the set symbol value from the storage.

19. The touch input recognition apparatus of claim 18, wherein when increment/decrement features of first and second coordinate values sequentially received from the touch input unit at the given time interval are different from each other, the controller determines the first coordinate value as a coordinate value of the inflection point.

20. The touch input recognition apparatus of claim 18, wherein the controller generates a symbol array based on the at least one set symbol value, retrieves the generated symbol array from the storage, and reads an event corresponding to the symbol value.

21. The touch input recognition apparatus of claim 18, wherein the controller acquires an accumulated distance between inflection points and the number of coordinate value inputs between the inflection points based on the received at least one coordinate value, and acquires a speed proportion value based on the accumulated distance and the number of coordinate value inputs.

22. The touch input recognition apparatus of claim 21, wherein the controller generates a symbol array configured with the symbol value and the speed proportion value and retrieves the generated symbol array from the storage.

23. The touch input recognition apparatus of claim 21, wherein the controller acquires the speed proportion value by computing the ratio of the accumulated distance to the number of coordinate value inputs.

24. A touch input recognition apparatus comprising:
a touch input unit configured to provide at least one coordinate value and a magnitude of a touch input corresponding to a touch trace at a given time interval;
a storage configured to store at least one of at least one symbol value and a symbol array configured with the at least one symbol value, and an execution event list corresponding to each of the at least one symbol value and the symbol array; and
a controller configured to receive the at least one coordinate value and the touch input magnitude, determine an inflection point based on the received at least one coordinate value, set a symbol value based on an increment/decrement feature of a coordinate value and a touch input magnitude provided between inflection points, and read an event corresponding to the set symbol value from the storage.
